(19) United States
(12) Patent Application Publication
(10) Pub. No.: US 2024/0306660 A1
(43) Pub. Date: Sep. 19, 2024

(54) SPECIALTY FOOD PRODUCTS AND METHODS FOR MANUFACTURING THE SAME

(71) Applicant: COASTAL COCKTAILS, INC., Irvine, CA (US)

(72) Inventor: Boaz SHONFELD, Irvine, CA (US)

(21) Appl. No.: 18/275,167

(22) PCT Filed: Feb. 2, 2022
(86) PCT No.: PCT/US2022/014876

§ 371 Date: Jul. 31, 2023

Related U.S. Application Data
(60) Provisional application No. 63/144,956, filed on Feb. 2, 2021.

(51) Int. Cl. A23G 1/54; A23G 1/00; A23G 1/56

(52) U.S. Cl. CPC A23G 1/545; A23G 1/0076; A23G 1/56

(57) ABSTRACT

Disclosed herein are a hot liquid preparation food product and method for making the same. According to some embodiments, the hot liquid preparation food product comprises an outer shell which is formed from an edible ingredient, such as chocolate or crystalline sugar, that melts when dropped or immersed in hot liquid, such as water or milk. The outer shell defines a void or space within which is contained a filler ingredient, such as powdered drink mix, liquid drink mix, alcohol, candy, marshmallow, spice, etc. Upon being dropped or immersed in hot liquid, the outer shell of the food product melts, thereby releasing the filler ingredient into the hot liquid and flavoring the liquid.

### CROSS REFERENCE TO RELATED APPLICATIONS

This patent application claims priority to U.S. Provisional Patent Application No. 63/144,956, “SPECIALTY FOOD PRODUCTS AND METHODS FOR MANUFACTURING THE SAME,” filed on 2 Feb. 2021, incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to food products, and more specifically to a specialty food products and methods for manufacturing the same.

### BACKGROUND OF THE INVENTION

In recent times, the market for gourmet and specialty food items has been expanding. Such items include novelty items and seasonal items. But competition in this area is fierce, and these food items may be trendy—popular one moment, but passé the next. Thus, anything which enhances user experience for a specialty food item will help to generate or maintain user interest in such item, and keep it relevant.

### BRIEF DESCRIPTION OF THE DRAWINGS

FIG. 1 illustrates a specialty food item.

FIG. 2 illustrates a specialty food item, according to some embodiments.

FIG. 3 is a flowchart that illustrate a method of making a specialty food, according to some embodiments.

FIG. 4 illustrates a specialty food item, according to some embodiments.

FIG. 5 illustrates examples of various shapes for a specialty food item, according to some embodiments

### DETAILED DESCRIPTION OF SOME EMBODIMENTS

This description and the accompanying drawings that illustrate aspects, embodiments, implementations, or applications should not be taken as limiting—the claims define the protected invention. Various mechanical, compositional, structural, and operational changes may be made without departing from the spirit and scope of this description and the claims. In some instances, well-known techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent to one skilled in the art, however, that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In recent times, the market for specialty and gourmet food items has been expanding. Specialty food items can include novelty items that may appeal to consumer because they are unique or different. Specialty food items can also include seasonal items, the market for which coincides with a particular season (e.g., spring, summer, fall, winter), time of the year, holiday (e.g., Christmas, Thanksgiving, Hanukkah, Passover, Easter, Halloween, Diwali, Festivus, Valentine's Day, Fourth of July, etc.), or event (e.g., birthday, anniversary).

One kind of specialty food item is artisanal-made hot chocolate preparations. Such preparations can be in the form of a solid piece of chocolate that is dropped or immersed in hot liquid (milk or water) to melt it, thereby flavoring the liquid. As used herein, “chocolate” refers generally to any chocolate mixture (comprising, e.g., cocoa, sugar, milk) whether sweet, semi-sweet, white, light, dark, etc. that can be formed into a solid piece (e.g., as opposed to granulated or powered). Some preparations may include limited additional ingredients, for example, marshmallows, dispersed throughout or contained in the center of the chocolate, which provide further flavor or variety to the resulting drink.

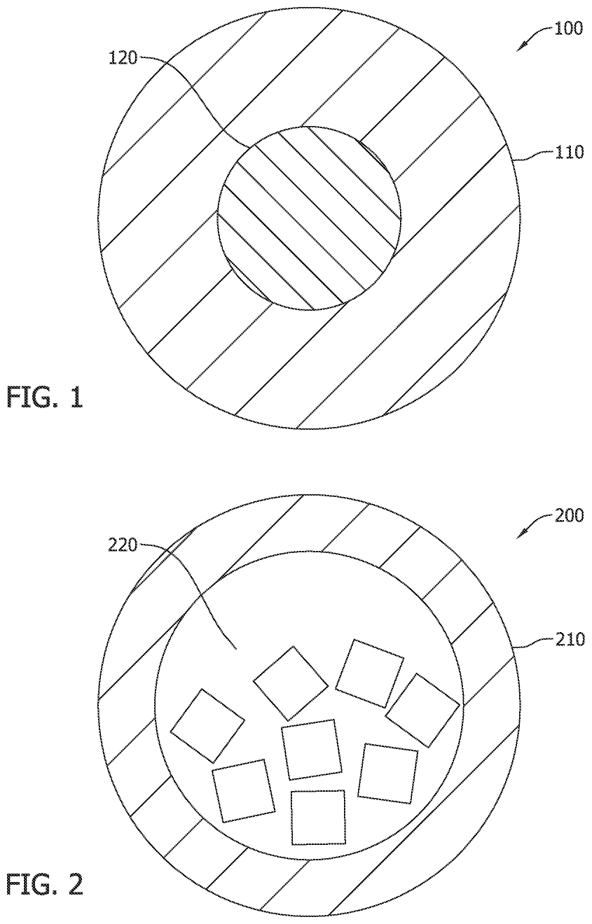

FIG. 1 illustrates an example of such hot chocolate preparations. FIG. 1 is a partial cross-sectional view of a hot chocolate preparation 100 formed as a solid piece of chocolate 110 with one or more additional ingredients 120 contained in the center of the chocolate. While such artisanal-made hot chocolate preparation in the form of a solid piece of chocolate (with or without additional ingredients contained therein) are known, there is room for improvement. For example, the experience of a user may not be completely satisfactory if s/he must wait for a perceived long time for the chocolate to melt and flavor the liquid, thus delaying the user's consumption of the resulting drink. Indeed, in a climate where some users expect instant gratification, any time spent waiting for the chocolate to melt may lead to a user becoming increasingly annoyed or agitated, and thus, viewing the hot chocolate preparation negatively.

According to some embodiments, hot chocolate preparation products and methods for making the same are provided to address such problems and concerns.

FIG. 2 illustrates a hot liquid preparation product 200, according to some embodiments. Referring to FIG. 2, which is a partial cross-sectional view, the product 200 is formed as a hollow shell 210. The shell 210 can be formed in a variety of shapes. As shown in FIG. 2, the shell 210 generally has the shape of a sphere. But in other embodiments, the shell can be shaped in other geometries (e.g., cube, pyramid, box, cylinder); shaped for a particular season, holiday, or event (e.g., hearts for Valentine's Day or anniversary, Christmas tree or ornament, Santa Claus, snowman, Hanukkiah for Hanukkah, Easter bunny or Easter egg, pumpkin, Jack-O-Lantern, skull, eyeball, etc.); other novelty shapes (e.g., sports gear, such as baseball, basketball, football, soccer ball, tennis ball, etc.; whimsical such as unicorn, seashell, starfish, seahorse, teddy bear, dinosaurs, etc.; promotional or related to popular culture, such as movies, television shows, etc.). Examples of these shapes for the outer shell are shown in FIG. 5.

The shell 210 is formed of an edible material or ingredient, such as a chocolate and/or sugar mixture, that is solid at a preferred storage temperature (e.g., room temperature, or refrigerated temperature), but will melt when brought into contact with a hot liquid (e.g., water or milk). For example, the shell ingredient can be a chocolate mixture (comprising, e.g., cocoa, sugar, milk) whether sweet, semi-sweet, white, light, dark, etc. that can be formed (e.g., molded) into a solid piece. When the product 200 formed with a shell of chocolate mixture is melted into a hot liquid, it will yield a hot chocolate or cocoa drink that can be consumed by the user. As another example, the shell ingredient can be a non-chocolate candy mixture (e.g., a sugar-based crystalline), likewise that can be formed into a solid piece. In some embodiments, the shell may have patterns formed, embossed, or printed thereon to provide for further visual interest, and/or facilitate melting, or melting in patterns. In some embodiments, the outer shell 210 of product 200 may be formed with other edible ingredients or fillings—e.g., sparkles, sprinkles, glitter, hard sugar crystals in one or more colors, etc.—to further enhance the flavor or appearance.

The product 200 further comprises one or more additional ingredients or fillings 220. Such fillings 220 can include powdered drink mixes (e.g. hot chocolate mix), liquid drink mixes, alcohol or liqueur, candies, marshmallows, pastes (nut butters, chocolate ganache), edible glitter, sprinkles, cookie pieces, coffee, tea, teabag, or any other suitable filling. The additional ingredients or fillings 220 are contained within the hollow, but not trapped or “locked” within the chocolate itself. Rather the fillings 220 are free to move about with the chocolate shell 210. As such, when a user shakes the product 200, s/he is rewarded with sensory feedback, which can tactile and/or auditory. For example, fillings 220 in solid form (e.g., sprinkles) may produce a sound like a shaker. Liquid fillings 220 may produce a swishing sound. And in either case, the user will feel that there is something within the product 200. This creates a sense of anticipation and expectation, thereby enhancing user experience.

In some embodiments, the shell 210 and/or fillings 220 can each be formed with a variety of edible ingredients that provide multiple colors or flavors for additional visual or taste interest. For example, in some embodiments, the fillings 220 can be formed as time-release capsules or components (similar to some medication), with varying layers or thicknesses of coatings that allow different flavors or colors to be presented at different times.

In some embodiments, the fillings 220 may be formed of an edible ingredient that has a higher melting temperature than the ingredient from which the outer shell 210 is formed. Thus, when the product 200 is immersed in hot liquid, the outer shell 210 melts away first, revealing the fillings 220 in solid form, thus providing a novel visual display for the user. Afterwards, the fillings 220 may also melt, e.g., to provide additional flavoring.

In some embodiments, the fillings 220 can themselves be formed in novelty shapes. In some embodiments, the shape of the fillings 220 can correspond to or relate to the shape of the outer shell. For example, the outer shell 210 may be formed in the shape of an Easter egg, and the filling 220 can be in the form of a chick or bunny. As another example, the outer shell 210 can be formed in the shape of a jewelry box, and the filling 220 can be formed as a jewelry item (e.g., ring or pendant). As another example, the outer shell 210 can be formed as a dollhouse, and the fillings 220 formed as miniature dolls.

In some embodiments, the product 200 may also include an aperture 230 that is formed in the hollow shell 210. When the product 200 is dropped, placed, or immersed in hot liquid, the aperture 230 allows the hot liquid to enter into the void or hollow of shell 210, and thereby make contact with the shell material from the inside. This facilitates or expedites the melting of the shell 210, for faster and more complete melting.

In some embodiments, the aperture may be covered or topped with a plug (not shown) to contain or keep the fillings 220 within the shell 210. In some embodiments, such plug can be formed of an edible ingredient, such as hard candy, that can be removed by the user when s/he is ready to use the product 200. The edible plug can be eaten or consumed by the user as an additional treat, further enhancing user experience.

In some embodiments, the product 200 may further comprise a wrapper (not shown) which covers and protects the shell 210, and for embodiments with an aperture 230, covers the aperture so that the fillings 220 do not leak or spill out. In some embodiments, the wrapper itself can be formed of an edible matter, e.g., edible foil.

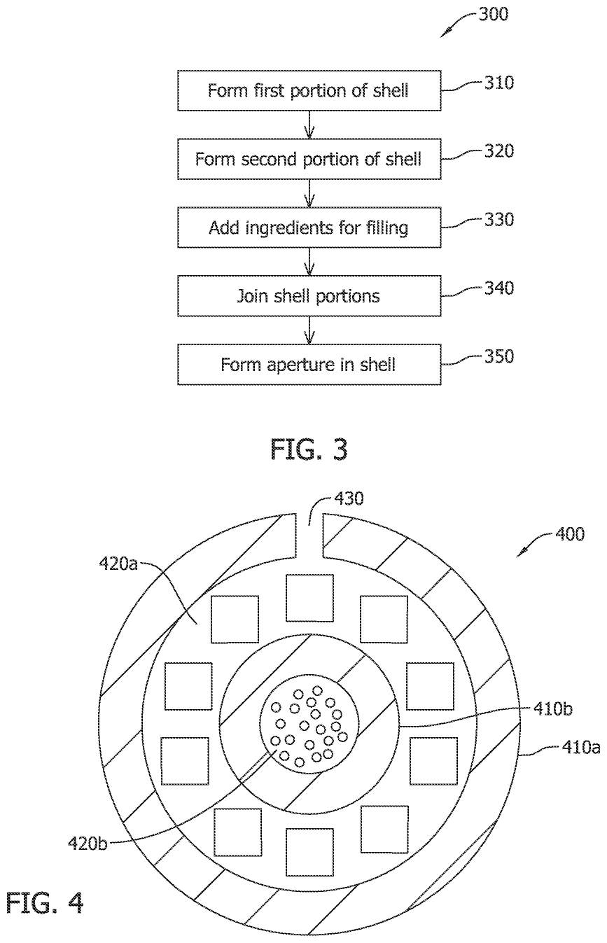

FIG. 3 is a flow chart for a method 300 for forming a hot liquid preparation product, according to some embodiments. In some embodiments, method 300 can be used or employed to form the product 200 shown and described with respect to FIG. 2.

At a process 310, a first portion of the outer shell 210 is formed, for example, by pouring a heated liquid edible shell ingredient (e.g., melted chocolate mixture, or melted sugar mixture) into suitable mold. The mold will form at least a portion of the desired shape for the final product 200—e.g., one-half of a sphere—once the liquid shell ingredient cools.

At a process 320, a second portion of the outer shell 210 is formed, for example, by a similar molding of the edible shell ingredient, to form another portion of the desired shape for the final product 200—e.g., the second half of a sphere.

In some embodiments, the mold portions can be formed so as to define any of various other geometries (e.g., cube, pyramid, box, cylinder) or novelty shapes for a particular season, holiday, or event (e.g., hearts for Valentine's Day or anniversary, Christmas tree or ornament, Santa Claus, snowman, Hanukkiah for Hanukkah, Easter bunny or Easter egg, pumpkin, Jack-O-Lantern, skull, eyeball, etc.); activity or theme (e.g., sports gear, such as baseball, basketball, football, soccer ball, tennis ball, etc.; whimsical such as unicorn, seashell, starfish, seahorse, teddy bear, dinosaurs, etc.; promotional or related to popular culture, such as movies, television shows, etc.).

In some embodiments, one or both molds may comprise or be formed of a semi-flexible material (e.g., plastic or silicone) that may be flexed or bent so that shell portion can be easily removed from the mold after it has cooled.

It is not necessary that processes 310 and 320 be performed sequentially. In some embodiments, additional processes for forming additional portions of the outer shell 210 may be provided to create more complex shapes for the end product 200. In some embodiments, these processes may be performed simultaneously or at least overlapping somewhat in time.

Importantly, one or more of the shell portions formed by processes 310 and 320 are formed hollow or with a cavity, for example, at the time of molding, or alternatively, by removing or extracting some part of the shell portion after molding.

After forming by molding, the portions (e.g., first and second) of the outer shell 210 are removed from the respective molds.

At a process 330, the additional ingredients for fillings 220 (whether liquid or solid) are inserted, poured, or otherwise added into the hollow or cavity of at least one portion of the outer shell 210.

At a process 340, the other portion of the outer shell 210 is joined with the shell portion into which the fillings 220 have been added. In some embodiments, the joining of the shell portions can be performed by melting an edge of one or both of the shell portions proximate the location of joining. The shell portions are brought together at the melted edge(s) and maintained or held in that position until the melted edge(s) cool off, and thus solidify to connect the shell portions.

At this point, the liquid preparation product 200 is in a form that could be used if so desired. That is, the product 200 could be dropped, immersed, or added into a hot liquid, which will melt the outer shell 210, thereby releasing the fillings 220. During this time, the user is presented with an entertaining visual display, which provides enhanced user satisfaction. The user can agitate, e.g., stir or shake, to combine or mix the shell 210 and fillings 220 ingredients of product 200 with the hot liquid, to produce a delicious beverage that can be consumed by the user.

In some embodiments, at a process 350, an aperture 230 is formed in the outer shell 310, for example, by boring or drilling. As previously described, the aperture 230 facilitates or expedites the melting of the shell 210, for faster and more complete melting, and enhanced user experience.

In some embodiments, the method 300 may be performed by a user or consumer her/himself. For example, a do-it-yourself (DIY) kit may be offered to users for making the hot liquid preparation product 200 according to the method 300. This DIY kit may include the ingredients for the shell 210 and one or a variety of fillings 220. The kit may also include suitable molds for forming the shell portions, as discussed above, and a rigid pointed object (e.g., pin) to form the aperture 230.

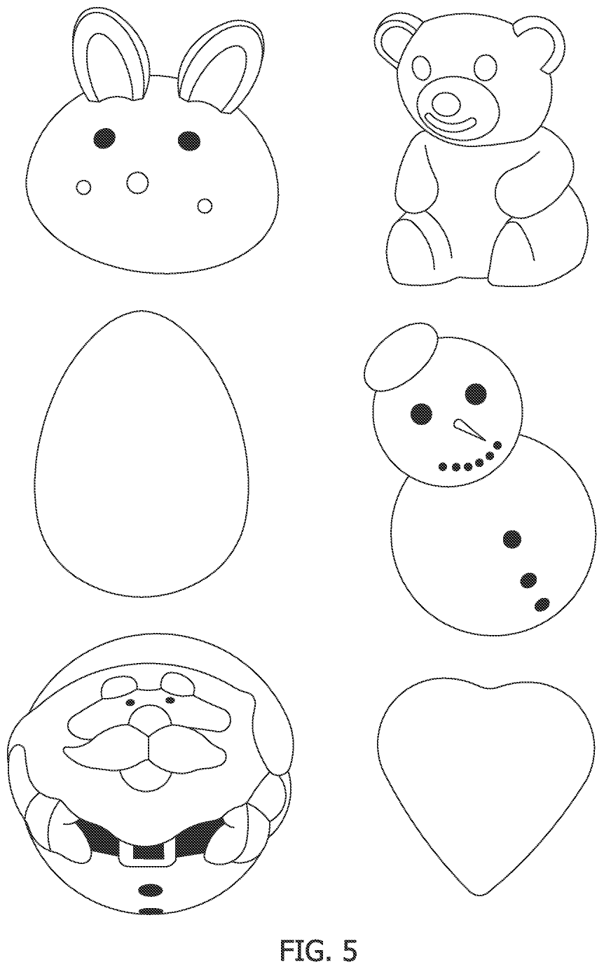

FIG. 4 illustrates a hot liquid preparation product 400, according to some embodiments. Referring to FIG. 4, which is a partial cross-sectional view, the product 400 is formed with a plurality of nested, hollow shells 410a and 410b. While two shells are shown in FIG. 4, it is contemplated that in other embodiments, additional hollow shells may be provided—i.e., like a Russian nesting Matryoshka doll. The shells 410a, 410b may be formed of the same or different chocolates or other edible, meltable materials. In some embodiments, the outer shell 410a may be formed with an aperture 430 through which hot liquid can enter to facilitate melting. In some embodiments, one or more of the outer nested shells may be formed with multiple openings or windows so the inner nested shells are visible or can be seen by a user; this can further enhance user interest or experience, with heighted visual interest as well as anticipation. In some embodiments, the openings in the outer nested shell can themselves be decorative; for example, an outer shell may be formed in the shape of a Jack-o-Lantern with openings for the eyes, nose, and mouth.

As seen in FIG. 4, a filling 420a, 420b is provided or enclosed in each shell 410. The same or different filling ingredient is used between layers, or no filling 420 may be provided between some layers.

The plurality of nested shells 410a, 410b and respective fillings 420a, 420b may be configured with different ingredients, shapes, and melting points so that the product 400 provides a series of interesting displays to entertain the user, and further increase or enhance user experience or satisfaction. As an example, an outer shell 410a of the product 400 may be formed in the shape of gift box or present, which will melt away to reveal an inner shell 410b that is shaped as a toy. As another example, an outer shell 410a of the product 400 may be formed in the shape of an egg, which will melt away to reveal an inner shell 410b that is shaped as a chick or bunny. As yet another example, an outer shell 410a may be formed in the shape of jewelry box, which will melt away to reveal an inner shell 410b or filling 420 that is shaped as a ring.

FIG. 5 illustrates examples of various shapes specialty food item, according to some embodiments.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures typically represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications.

1. A method for forming a hot liquid preparation food product, the method comprising:
forming a first portion of an outer shell for the food product by pouring a first amount of heated liquid edible shell ingredient into a first mold portion and allowing the first amount to cool;
forming a second portion of the outer shell for the food product by pouring a second amount of the heated liquid edible shell ingredient into a second mold portion and allowing the second amount to cool;
removing the first and second portions of the outer shell from the respective first and second mold portions after cooling of the first and second amounts of heated liquid edible shell ingredient;
wherein at least one of the first or second portions of the outer shell comprises a first cavity;
inserting an edible filler into the first cavity; and
joining the first and second portions of the outer shell to encapsulate the edible filler within a void of the outer shell and form the completed hot liquid preparation food product;
wherein the completed hot liquid preparation food product may be immersed in a hot liquid to melt the outer shell and provide an enhanced user experience.

2. The method of claim 1 wherein the heated liquid edible shell ingredient comprises a chocolate mixture.

3. The method of claim 1 wherein the outer shell is formed in a novelty shape.

4. The method of claim 1 wherein the edible filler is formed in a novelty shape.

5. The method of claim 1 further comprising forming an aperture in the outer shell, wherein such aperture allows the hot liquid to enter into the void of the shell to facilitate melting of the hot liquid preparation food product.

6. The method of claim 5 further comprising closing the aperture with a plug, wherein such plug is removable by the user.

7. The method of claim 6 wherein the plug is edible.

8. The method of claim 5 further comprising closing the aperture with a plug, wherein such plug is removable by the user.

9. The method of claim 1 further comprising forming the edible filler.

10. The method of claim 9 wherein forming the edible filler comprises:
forming a first portion of an inner shell for the food product by pouring a third amount of heated liquid edible shell ingredient into a third mold portion and allowing the third amount to cool;
forming a second portion of the inner shell for the food product by pouring a fourth amount of the heated liquid edible shell ingredient into a fourth mold portion and allowing the fourth amount to cool;
removing the first and second portions of the inner shell from the respective third and fourth mold portions after cooling of the third and fourth amounts of heated liquid edible shell ingredient; and
wherein at least one of the first or second portions of the inner shell comprises a second cavity;
inserting an edible fill ingredient into the second cavity; and
joining the first and second portions of the inner shell to encapsulate the edible fill ingredient within a void of the inner shell.

11. A hot liquid preparation food product comprising:
an outer shell formed from a first edible ingredient that is solid at a preferred storage temperature but will melt when brought into contact with a hot liquid, the outer shell defining a void; and
an edible filler disposed in the void of the outer shell, the edible filler formed of a second edible ingredient;
wherein the hot liquid preparation food product may be immersed in the hot liquid to melt the outer shell and provide an enhanced user experience.

12. The hot liquid preparation food product of claim 11 wherein the first edible ingredient comprises a chocolate mixture.

13. The hot liquid preparation food product of claim 11 wherein the outer shell is formed in a novelty shape.

14. The hot liquid preparation food product of claim 11 wherein the edible filler is formed in a novelty shape.

15. The hot liquid preparation food product of claim 11 wherein the outer shell comprises an aperture, wherein such aperture allows the hot liquid to enter into the void of the outer shell to facilitate melting of the hot liquid preparation food product.

16. The hot liquid preparation food product of claim 15 further comprising a plug disposed within the aperture, wherein such plug is removable by the user.

17. The hot liquid preparation food product of claim 16 wherein the plug is edible.

18. The hot liquid preparation food product of claim 11 wherein the second edible ingredient is solid at a preferred storage temperature and will melt at a higher temperature than the first edible ingredient.
